(19) United States
(12) Patent Application Publication
(10) Pub. No.: US 2010/0154494 A1
(43) Pub. Date: Jun. 24, 2010

(54) CONNECTING ADAPTOR FOR ELECTRIC CYLINDER CORRESPONDING TO MORTISE LOCK

(75) Inventors: Nobuyo Sakai, Toshima-ku (JP); Yoshimasa Kataumi, Toshima-ku (JP)

Correspondence Address: DAY PITNEY LLP, 7 TIMES SQUARE, NEW YORK, NY, 10036-7311, US

(73) Assignee: KEIDEN SANGYO CO., LTD., Toshima-ku (JP)

(21) Appl. No.: 12/622,510

(22) Filed: Nov. 20, 2009

(30) Foreign Application Priority Data
Dec. 18, 2008 (JP) 2008-322209

(51) Int. Cl. E05B 47/00

(52) U.S. Cl. 70/277

(57) ABSTRACT

A connecting adaptor for an electric cylinder to operate a door lock is provided having a screw type connecting member assembly D₁ comprising a screw type connecting member 2, in which a cam bar 4, a cam bar extruding plates 5, and a cam bar return spring 6 are incorporated, is screwed into an internal thread portion C₁ of an existing lock case C of a door, that a connecting plate assembly D₂ comprising a connecting plate 3, in which a locking pin 7 and a locking pin return spring 8 are incorporated, is secured to the electric cylinder 1 with connecting plate fixing screws 9, that a projection (a) at the lower end of the connecting plate 3 secured to the electric cylinder 1 is inserted into a square hole b₂ of the screw type connecting member 2, that a screw C₆ is fastened into the lock case C with a screw driver C₇, so that on one hand, the stop of rotation of the screwed screw type connecting member assembly D₁ is made, and on the other hand, the electric cylinder 1 is fixed in such a manner that the cam extruding plate 5 is pressed by the screw C₆, the cam bar 4 is moved in circular arc motion, and the locking pin 7 is raised until it is caught by a square hole b₁ of the screw type connecting member 2.

### BACKGROUND OF THE INVENTION

This invention relates to a connecting adaptor which, after removing the cylinder of an existing lock for opening and closing the door, allows an electric cylinder for operation of the door lock to be attached to a lock case of the existing lock, with the wire receiving an electric signal being secured to the electric cylinder operable with the electric signal.

### BACKGROUND ART

The existing lock for opening and closing the door is generally designed to use a key, so that the key is often carried and lost, or picking can occurs which is carried out by inserting a special tool or a picking tool into the key hole of the lock for unlocking. However, when a lock without a key hole is placed on the door, its provision was often accompanied by an expensive construction. Meanwhile, recently the construction of the lock for preventing unauthorized unlocking without using a suitable key has been proposed (For example, refer to Patent Document 1). However, these locks had to be provided on the door when they are being built, or required to reform the door.

In view of the above-mentioned state, the applicant has developed an electric cylinder for operation of a door lock operable with an electric signal, which after removing the cylinder of the existing lock for opening and closing the door, is attached to the existing lock. The above-mentioned electric cylinder has been widely used as the lock preventing unauthorized unlocking, and was patented in many countries, for example, as U.S. Pat. No. 7,231,791

In the existing mortise lock in the prior art, as shown in FIG. 11, when a cylinder C₂ is attached to a lock case C provided with an internal thread portion C₁, the cylinder C₂ provided with an external thread portion C₃ is rotated and screwed. Accordingly, this mortise lock has a construction such that the amount of screwing the cylinder is changed according to the wall thickness, and when the position is determined, a screw C₆ is fastened with a screw driver C₇, to thereby stop the rotation of the screwed cylinder C₂. In the electric cylinder 1 described in the above-mentioned U.S. Pat. No. 7,231,791, when removing the cylinder of the above-mentioned existing mortise lock, and attaching the electric cylinder 1 in a similar manner to the above-mentioned mortise lock, as shown in FIG. 12, a connecting adaptor C₅ provided with an external thread portion C₄ attached to the electric cylinder 1 is turned and screwed into the internal thread portion C₁. In this case, attaching and detaching the electric cylinder 1 by said screwing method is not only difficult as viewed in wiring of the electric wire, but also causes the danger of breaking the wire.

In this way, when this electric cylinder is attached to the lock case, with the wire receiving an electric signal being fixed to the electric cylinder, the problem that the wire is twisted due to the free rotation of the electric cylinder arises. See JP-2002-276215 A and U.S. Pat. No. 7,231,791.

A problem of the invention is to provide a connecting adaptor, which comprises a screw type connecting member screwed in and fixed to the existing lock case of the door, and a connecting plate connectable to an elastic cylinder, which can be placed on the mortise lock without twisting the wire.

### SUMMARY OF THE INVENTION

The above problem is solved in accordance with the present invention by a connecting means for an electric cylinder to operate the door lock, characterized in that a screw type connecting member assembly D₁ comprising a screw type connecting member 2, in which a cam bar 4, a cam bar extruding plates 5, and a cam bar return spring 6 are incorporated, is screwed into an internal thread portion C₁ of an existing lock case C of a door, that a connecting plate assembly D₂ comprising a connecting plate 3, in which a locking pin 7 and a locking pin return spring 8 are incorporated, is secured to the electric cylinder 1 with connecting plate fixing screws 9, that a projection (a) at the lower end of the connecting plate 3 secured to the electric cylinder 1 is inserted into a square hole b₂ of the screw type connecting member 2, that a screw C₆ is fastened into the lock case C by a screw driver C₇, so that on one hand, the stop of rotation of the screwed screw type connecting member assembly D₁ is made, and on the other hand, the electric cylinder 1 is fixed in such a manner that the cam extruding plate 5 is pressed by the screw C₆, the cam bar 4 is moved in circular arc motion, and the locking pin 7 is raised until it is caught by a square hole b₁ of the screw type connecting member 2, whereby the stop of rotation and the fixation are carried out at a time.

The construction of this invention enables the electric cylinder 1 to be simply and easily attached and detached to the existing lock case C of the door by fastening the screw C₆ with the screw driver C₇, without carrying out any special working. Furthermore, twisting of the electric wire and breaking of the wire do not occur. Moreover, since this invention has a construction that the screw C₆ which stops the rotation of the cylinder C₂ screwed as in the existing lock is utilized, the stop of rotation of the screw type connecting member assembly D₁ and the fixation of the electric cylinder, can be carried out simultaneously.

The invention based on claim 2, has a feature in that in the screw type connecting member assembly D₁, a cam interlocking gear 11 is fixed to an interlocking adaptor 10 by gear fixing screws 12 so that rotation is transmitted to the interlocking adaptor 10 through the hole 2₄ on the back 2₃ of the threaded tubular step portion 2₁ of the screw type connecting member 2. This construction enables the dead bolt to be actuated by operation of the electric cylinder.

The invention based on claim 3, has a feature in that the screw type connecting member assembly D₁ comprises a two-stepped tubular, screw type connecting member 2 having a threaded tubular step portion 2₁ and a tubular portion 2₂ provided with two square holes b₁, b₂ , a cam interlocking gear 11 fixed to a hole 2₄ on the back 2₃ of the threaded tubular step portion 2₁ by gear fixing screws 12, cam bar extruding plates 5 inserted into two long grooves c of the tubular portion 2₂, a cam bar return spring 6, which is incorporated into the interior of the screw type connecting member 2 in such a manner that the head 6₁ is placed on the projection within the screw type connecting member 2, and the foot 6₂ engage the groove 4₁ of the cam bar 4, and a cam bar 4 in the form of bilateral symmetry, which is housed within the screw type connecting member 2, with the foot 6₂ of the cam bar return spring 6 engaging the groove 4₁. This construction enables this electric cylinder 1 to be placed and fixed corresponding to any door which opens to the right or to the left.

### BRIEF DESCRIPTION OF THE DRAWINGS

In the accompanying drawings:

FIG. 1 is an exploded perspective view of the connecting adaptor of this invention removed from an electric cylinder 1;

FIG. 2 is an exploded perspective view of the disassembled connecting adaptor of this invention, as viewed in the direction opposite to FIG. 1;

FIG. 3 shows the disassembled state of the connecting adaptor of this invention in a plan view and a side sectional view,

FIG. 4 is a perspective view showing a state before screwing a screw type connecting member assembly D₁ of the connecting adaptor of this invention into the lock case C of the existing mortise lock;

FIG. 5 is a perspective view showing a state before attaching an electric cylinder 1 after the screw type connecting member assembly D₁ was screwed;

FIG. 6 is a perspective view showing a state of fixing the attached electric cylinder 1 by fastening a screw C₆ with a driver C₇;

FIG. 7 shows the state in FIG. 4 in a sectional view;

FIG. 8 shows the state in FIG. 5 in a sectional view;

FIG. 9 shows the state in FIG. 6 in a sectional view;

FIGS. 10a and 10b are front views showing the interior of the screw type connecting member assembly D₁;

FIG. 10c is a front view showing a state at the time when incorporating a cam bar return spring 6 and a cam bar 4 into the screw type connecting member assembly D₁;

FIG. 10d is a front view after installation;

FIG. 10e is a side sectional view after installation;

FIG. 11 shows an existing mortise lock which is a screwing type attachment; and

FIG. 12 shows an electric cylinder in the prior art which is a screwing type attachment.

### DETAILED DESCRIPTION OF THE PREFERRED EMBODIMENT

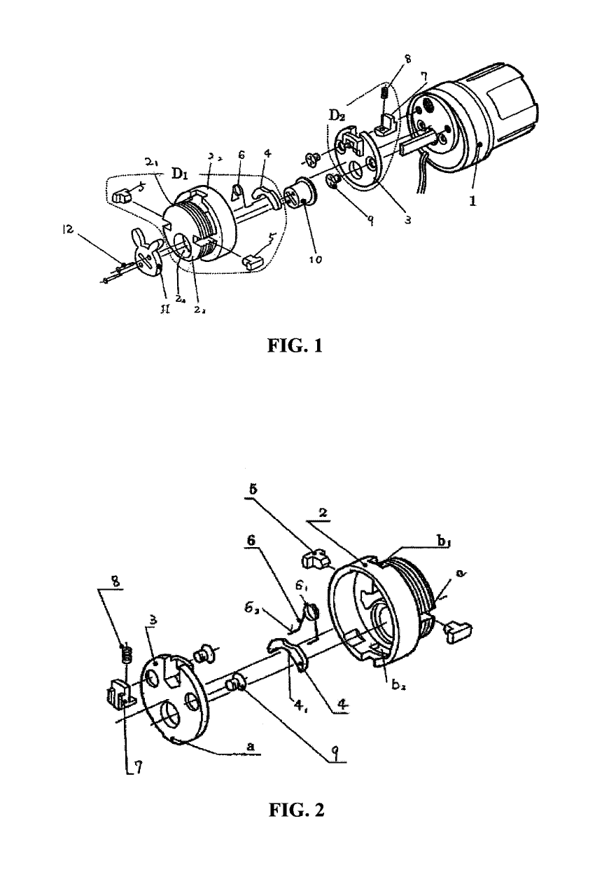

Referring to FIG. 1, the connecting adaptor of this invention comprises a screw type connecting member assembly D₁ and a connecting plate assembly D₂. The screw type connecting member assembly D₁ is an assembly assembled by incorporating a cam bar 4, cam bar extruding plates 5, and a cam bar return spring 6 into the screw type connecting member 2. Furthermore, the connecting plate assembly D₂ is an assembly assembled by incorporating a locking pin 7, and a locking pin return spring 8 into a connecting plate 3.

FIG. 1 also shows the connecting adaptor of this invention and the construction for operating the existing lock (an interlocking adaptor 10, a cam interlocking gear 11, and gear fixing screws 12). A transmission force is transmitted to the cam interlocking gear 11 by the operation of rotating the electric cylinder 1, thereby carrying out the locking and unlocking of the existing lock. The interlocking adaptor 10 is passed through the screw type connecting member 2, and the cam interlocking gear 11 is fixed to the interlocking adaptor 10 for transmission of rotation with the gear fixing screws 12.

In the screw type connecting member assembly D₁, the interlocking adaptor 10 is passed through a hole 2₄ in the lock 2₃ of the threaded tubular step portion 2₁ of the screw type connecting member 2, and the cam interlocking gear 11 is fixed to the interlocking adaptor 10 for transmission of rotation with the gear fixing screws 12. In the screw type connecting member assembly D₁, the cam bar 4, the cam bar extruding plates 5, and the cam bar return spring 6 are incorporated into the screw type connecting member 2.

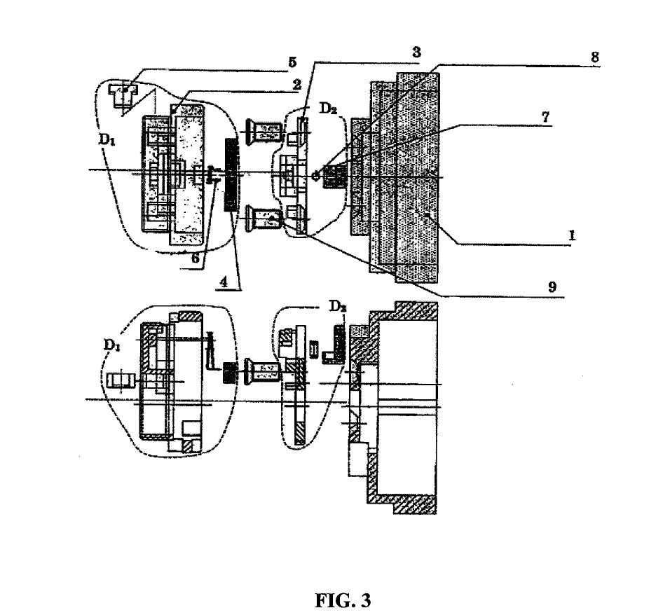

Referring to FIGS. 2 and 3, in this screw type connecting member assembly D₁, the cam bar return spring 6 is incorporated into the interior of the screw type connecting member 2 in such a manner that the head 6₁ is placed on the projection in the interior of the screw type connecting member 2 and the foots 6₂ engage the groove 4₁ of the cam bar 4. Moreover, the connecting plate assembly D₂ comprises the locking pin 7 and the locking pin return spring 8 which are placed on the upper groove 3₁ of the connecting plate 3, and is fixedly attached to the electric cylinder 1 with the connecting plate fixing screws 9.

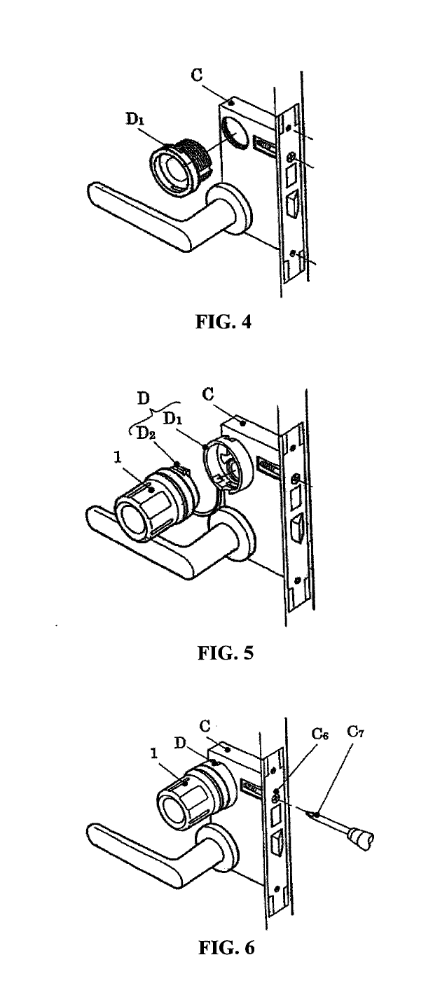

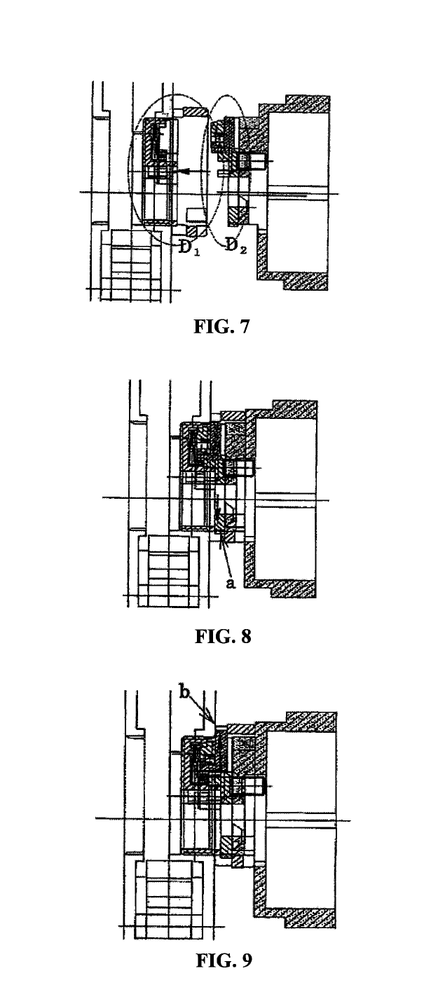

FIG. 4 shows a state before screwing the screw type connecting member assembly D₁ of the connecting adaptor of this invention into the lock case C of the existing mortise lock, FIG. 5 shows a state before attaching the electric cylinder 1 after screwing the screw type connecting member assembly D₁, and FIG. 6 shows a state of fixing the electric cylinder 1 by fastening the screw C₆ with a screw driver C₇ after attaching the electric cylinder 1.

First, the cylinder C₂ is removed from the existing mortise lock. As shown in FIG. 4, the screw connecting member assembly D₁ of this invention is screwed into the lock case C from which the cylinder C₂ is removed, and the connecting plate assembly D₂ assembled by incorporating the locking pin 7 and the locking pin return spring 8 into the connecting plate 3, is fixed to the electric cylinder 1 with the bolts 9. Subsequently, the projection a (FIG. 3) at the lower end of the connecting plate 3 fixed to the electric cylinder 1 is inserted into the square hole b₂ (FIG. 2) of the screw type connecting member 2 (FIG. 8), the screw C₆ is fastened into the lock case C with a driver C₇ (FIG. 6), so that on one hand, the stop of rotation of the screwed screw type connecting member assembly D₁ is made, and on the other hand, the cam extruding plate 5 is pressed by the screw C₆, the cam bar 4 is moved in circular arc motion, the locking pin 7 is raised until it is caught by the square hole b₁, so that the electric cylinder 1 is fixed. In this way, the stop of rotation and the fixation are carried out at a time (FIG. 9).

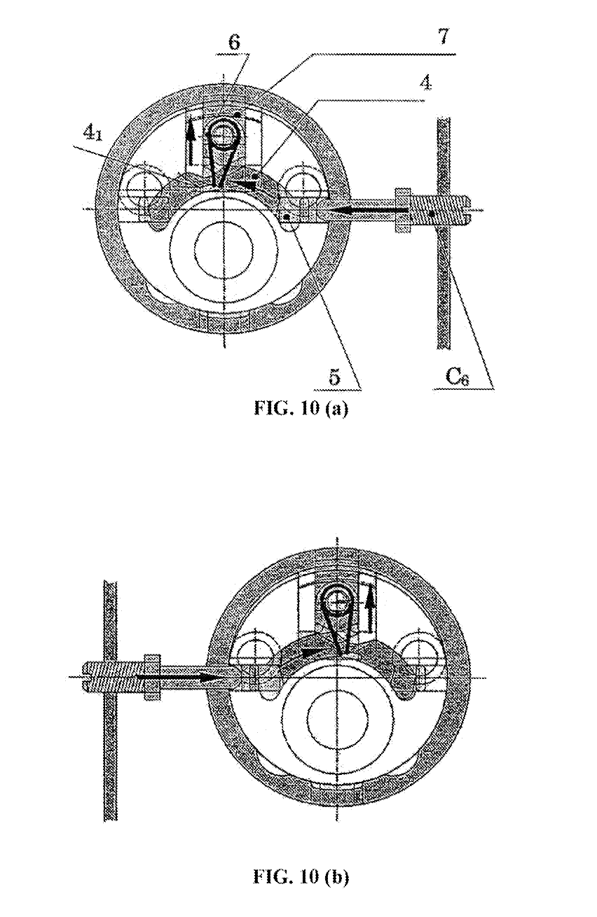

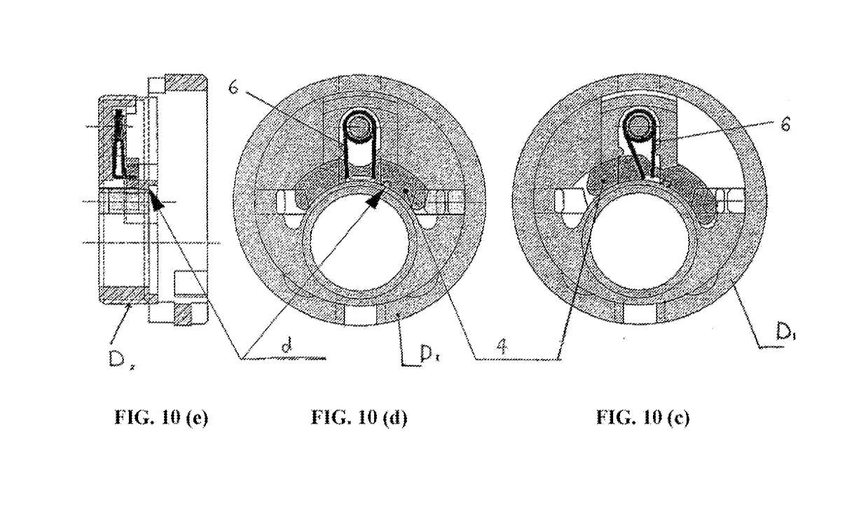

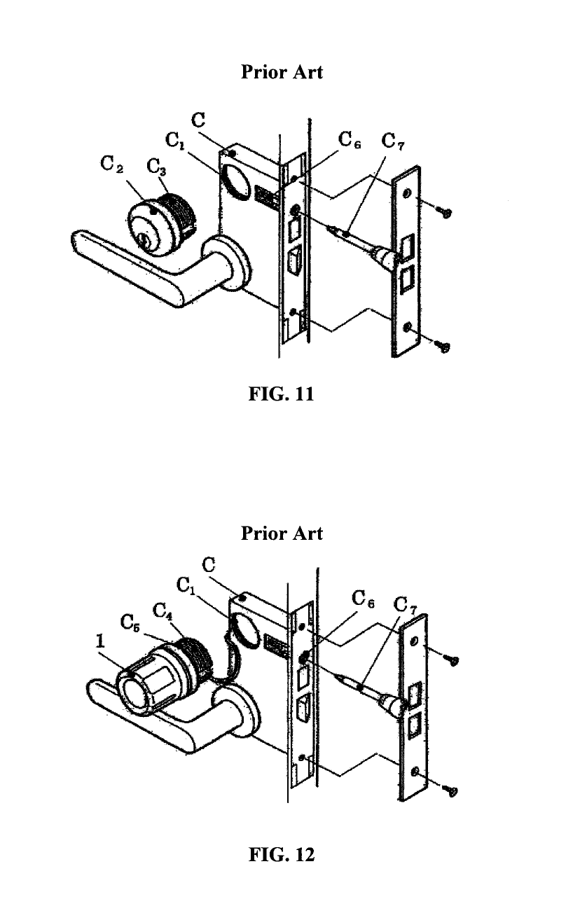

Fastening the screw C₆ into the lock case with a driver enables on one hand the stop of rotation of the screwed screw type connecting member assembly D₁ to be made, and on the other hand, enables the electric cylinder 1 to be fixed in such a manner that the cam extruding plate 5 is pressed by the screw C₆, the cam bar 4 is moved in circular arc motion, and the locking pin 7 is raised until it is caught by the square hole b₁ of the screw type connecting member 2. In this way, the stop of rotation and the fixation of the electric cylinder 1 can be carried out at a time (FIG. 9). The arrow mark in FIG. 10 shows the movement of the locking pin 7.

In this way, the cam bar return spring 6 and the cam bar 4 incorporated into the interior of the screw type connecting member assembly D₁ as well as the inner construction of the screw type connecting member assembly D₁ are formed in symmetry. This construction allows the connecting assembly which is not influenced by the direction of opening the door.

Furthermore, FIG. 10c is a front view showing a state at the time when incorporating the cam bar return spring 6 and the cam bar 4 into the screw type connecting member assembly D₁, FIG. 10d is a front view after incorporating them, and FIG. 10e is a side sectional view. The cam bar return spring 6 and the cam bar 4 are incorporated into the interior of the screw type connecting member assembly D₁ in the relationship of the state shown in FIG. 10c. After the cam bar return spring 6 and the cam bar 4 have been incorporated in the interior of the screw type connecting member assembly D₁, disengagement of the cam bar return spring 6 and the cam bar 4 are prevented by a projection d provided on the screw type connecting member, as shown in FIGS. 10d and 10e.

Having thus described the invention, what is claimed is:

1. A connecting adaptor for an electric cylinder to operate a door lock, said electric cylinder having a motor which extends and contracts a motor shaft by changing the electrode of said motor, a tailpiece being linked to said extending and contracting operation to actuate a dead bolt, characterized in that a screw type connecting member assembly D₁ comprising a screw type connecting member 2, in which a cam bar 4, a cam bar extruding plates 5, and a cam bar return spring 6 are incorporated, is screwed into an internal thread portion C₁ of an existing lock case C of a door, that a connecting plate assembly D₂ comprising a connecting plate 3, in which a locking pin 7 and a locking pin return spring 8 are incorporated, is secured to the electric cylinder 1 with connecting plate fixing screws 9, that a projection (a) at the lower end of the connecting plate 3 secured to the electric cylinder 1 is inserted into a square hole b₂ of the screw type connecting member 2, that a screw C₆ is fastened into the lock case C with a screw driver C₇, so that on one hand, the stop of rotation of the screwed screw type connecting member assembly D₁ is made, and on the other hand, the electric cylinder 1 is fixed in such a manner that the cam extruding plate 5 is pressed by the screw C₆, the cam bar 4 is moved in circular arc motion, and the locking pin 7 is raised until it is caught by a square hole b₁ of the screw type connecting member 2, whereby the stop of rotation and the fixation are carried out at a time.

2. The connecting adaptor for an electric cylinder to operate a door lock of claim 1, characterized in that in the screw type connecting member assembly D₁, a cam interlocking gear 11 is fixed to an interlocking adaptor 10 by gear fixing screws 12 so that the rotation is transmitted to the interlocking adaptor 10 through the hole 2₄ on the back 2₃ of the threaded tubular step portion 2₁ of the screw type connecting member 2.

3. The connecting adaptor for an electric cylinder to operate a door lock of claim 1, characterized in that the screw type connecting member assembly D₁ comprises a two-stepped tubular, screw type connecting member 2 having a threaded tubular step portion 2₁ and a tubular portion 2₂ provided with two square holes b₁, b₂ , a cam interlocking gear 11 fixed to a hole 2₄ on the back 2₃ of the threaded tubular step portion 2₁ by gear fixing screws 12, cam bar extruding plates 5 inserted into two long grooves c of the tubular portion 2₂, a cam bar return spring 6, which is incorporated into the interior of the screw type connecting member 2 in such a manner that the head 6₁ is placed on the projection within the screw type connecting member 2, and the foot 6₂ engage the groove 4₁ of the cam bar 4, and a cam bar 4 in the form of bilateral symmetry, which is housed within the screw type connecting member 2, with the foot 6₂ of the cam bar return spring 6 engaging the groove 4₁.
